(19) United States
(12) Patent Application Publication
(10) Pub. No.: US 2021/0065305 A1
(43) Pub. Date: Mar. 4, 2021

(54) METHOD AND APPARATUS FOR PROCESSING DATA USING ARTIFICIAL INTELLIGENCE TO DETERMINE GOALS

(71) Applicant: Forwardlane Inc, New York, NY (US)

(72) Inventors: Nathan STEVENSON, New York, NY (US); Peter RHINES, New York, NY (US); Scott R. MIXER, Montclair, NJ (US)

(21) Appl. No.: 17/003,683

(22) Filed: Aug. 26, 2020

Related U.S. Application Data
(60) Provisional application No. 62/891,702, filed on Aug. 26, 2019.

(51) Int. Cl. G06Q 40/06; G06N 5/04; G06F 40/279; G06N 5/02; G06N 3/08; G06F 40/40; G06F 16/25

(52) U.S. Cl. CPC G06Q 40/06; G06N 5/04; G06F 40/279; G06F 16/254; G06N 3/08; G06F 40/40; G06N 5/025

(57) ABSTRACT

An approach is provided for determining financial/business goals from multiple data sources by applying artificial intelligence models. The approach involves, for example, collecting unstructured data relating to at least one user from one or more data sources. The approach also involves processing the unstructured data to determine the at least one goal and contextual data related to the at least one goal. The approach further involves extracting the contextual data related to the at least one goal from the unstructured data. The approach also involves classifying the contextual data related to the at least one goal into a first confidence data or a second confidence data, wherein the first confidence data has a higher confidence level than the second confidence data. The approach further involves integrating the second confidence data with a structured data. The approach also involves causing presentation of the integrated data via a graphical user interface.

### RELATED APPLICATION

This application claims priority of U.S. Provisional Patent Application Ser. No. 62/891,702, entitled “METHOD AND APPARATUS FOR PROCESSING DATA USING ARTIFICIAL INTELLIGENCE TO DETERMINE GOALS,” filed on Aug. 26, 2019, the contents of which are hereby incorporated herein in their entirety by this reference.

### BACKGROUND

Services professionals, e.g., wealth managers and advisors, face the daunting task of delivering high performance for all clients, while providing highly personalized service and attention. In the financial services sector, the advisor must dedicate significant time to research, form strategies, and administer portfolio allocations in alignment with the clients' financial goals; these activities ironically detract from engaging with their clients to learn and understand each of the clients' evolving goals. Although customer relationship management (CRM) systems help with retaining useful, relevant information about clients, these systems can generate voluminous data about such clients, particularly in the case of a wealth manager who has a large book. Despite the large repository of personalized information, it can be impractical for the advisor to analyze such information for all but the top clients.

### SOME EXAMPLE EMBODIMENTS

Therefore, there is a need for an approach for determining goals (e.g., financial, business, etc.) from multiple data sources by applying artificial intelligence models.

According to one embodiment, a method for determining at least one goal by applying artificial intelligence, comprising collecting unstructured data relating to at least one user from one or more data sources. The method also comprises processing the unstructured data to determine the at least one goal and contextual data related to the at least one goal. The method further comprises extracting the contextual data related to the at least one goal from the unstructured data. The method also comprises classifying the contextual data related to the at least one goal into a first confidence data or a second confidence data, wherein the first confidence data has a higher confidence level than the second confidence data. The method further comprises integrating the second confidence data with a structured data. The method also comprises causing a presentation of the integrated data via a graphical user interface.

According to another embodiment, an apparatus comprises at least one processor, and at least one memory including computer program code for one or more computer programs, the at least one memory and the computer program code configured to, with the at least one processor, cause, at least in part, the apparatus to collect unstructured data relating to at least one user from one or more data sources. The apparatus is further caused to process the unstructured data to determine the at least one goal and contextual data related to the at least one goal, to extract the contextual data related to the at least one goal from the unstructured data, and to classify the contextual data related to the at least one goal into a first confidence data or a second confidence data, wherein the first confidence data has a higher confidence level than the second confidence data. The apparatus is further caused to integrate the second confidence data with a structured data and to initiate presentation of the integrated data via a graphical user interface.

According to one embodiment, a system determining at least one goal by applying artificial intelligence, comprising a data processing module configured to aggregate data relating to at least one user from one or more data sources. The system also comprises a database configured to store the aggregated data. The system further comprises an artificial intelligence platform configured to process the aggregated data using a natural language processing (NLP) mechanism, to modify the aggregated data with metadata, and to apply an artificial intelligence (AI)/machine learning (ML) process on the aggregated data to generate a recommendation. The system further comprises causing a presentation module configured to cause a presentation of the recommendation via a graphical user interface.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between a service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining financial/business goals from multiple data sources by applying artificial intelligence models, according to one example embodiment;

FIG. 2 is a diagram of the components of a data analysis platform 109, according to one example embodiment; and

FIG. 3 is a flowchart of a process for determining financial/business goals from multiple data sources by applying artificial intelligence models, according to one example embodiment;

FIG. 4 is a diagram that represents a reference architecture for determining financial/business goals from multiple data sources by applying artificial intelligence models, according to one embodiment;

FIG. 5 is a diagram that represents a common reference data model, according to one embodiment;

FIG. 6A is a flowchart of a process for integrating contextual data with a lower confidence level with structured data for data accuracy, according to one embodiment;

FIG. 6B is a flowchart of a process for generating recommendations based on configured rule and the rating information, according to one embodiment;

FIG. 6C is a flowchart of a process for entering business rules and predicting a user response, according to one embodiment;

FIG. 6D is a flowchart of a process for extracting contextual data, according to one embodiment;

FIG. 6E is a flowchart of a process for managing notes corresponding to a user, according to one embodiment;

FIG. 6F is a flowchart of a process for designating at least one goal and unstructured data, according to one embodiment;

FIG. 7A is a flowchart of a process for generating a recommendation on the ingested aggregated data relating to a user, according to one embodiment;

FIG. 7B is a flowchart of a process for designating the ingested aggregated data according to classification criteria, according to one embodiment;

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset) that can be used to implement an embodiment

### DESCRIPTION OF SOME EMBODIMENTS

Examples of a method, apparatus, and computer program for determining financial/business goals from multiple data sources by applying artificial intelligence models are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

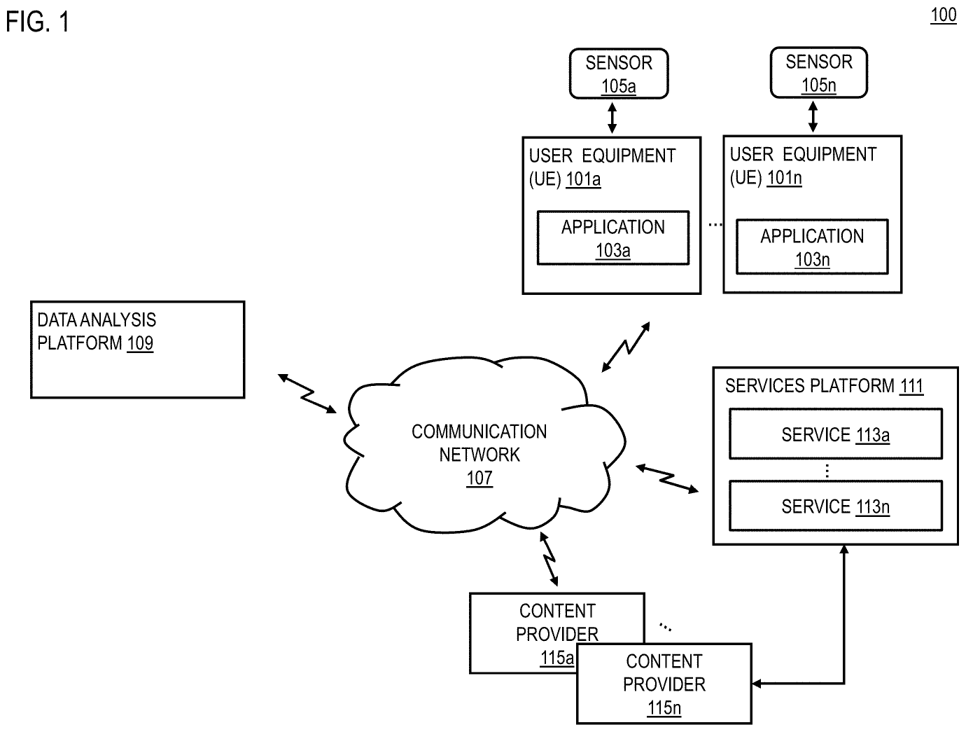

FIG. 1 is a diagram of a system capable of determining goals from multiple data sources by applying artificial intelligence models, according to one embodiment. Although various embodiments of system 100 are described with respect to financial and/or business goals, it is contemplated that any objective or goal relating to any other activities of a user can be determined. With respect to wealth management, for example, traditionally, investors have relied on investment advisors to manage their investment portfolios; however, investment advisors are expensive, and the investors who use such advisors often have complex financial portfolios. Furthermore, some investors have difficulty in accessing investment advisors because of minimum balances or investment funds requirements, geographic distance limitations, and conventional structuring or practices of financial institutions. It is recognized that investors are increasingly reliant on computer-based financial analysis tools that provide them with a summary of their financial health. Such tools typically calculate life expectancy and future assets from minimal data, e.g., age, income, expenses, marital status, asset information, and loan amount. Such predictions provide little accuracy in that these financial analysis tools do not account for other relevant information, e.g., the investors' health-related information, genetic background, lifestyle, medical status, etc. Predictions of financial futures require much more information to be reasonably accurate and to provide a more realistic summary of the financial future. However, collecting and analyzing such information poses significant technical challenges due, in part, from volume and from the fact that such information is largely unstructured and exists across multiple systems.

To address this problem, system 100 of FIG. 1 introduces the capability to retrieve data from a myriad of public and/or private data sources to develop a financial/business goal. System 100 applies artificial intelligence (AI) models to process the retrieved data and identify relevant goals and related contextual information pertaining to at least one investor, e.g., a user. Thereafter, system 100 combines the relevant goals and related contextual information with structured client profile data. The structured client profile data comprises of portfolio and holdings information. Subsequently, system 100 generates signal across one or more clients to dynamically surface goal-based insight. In one example embodiment, system 100 identifies retirement goals, e.g., planning and discussions around retirement savings and contributions. In another example embodiment, system 100 identifies other useful goals, e.g., planning for future education-related expenses, on-going expenses, and lifestyle choices, future purchases, cash outlays, and accumulation goals, etc.

As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to a data analysis platform 109 via a communication network 107, e.g., a wireless communication network. In one embodiment, the data analysis platform 109 performs one or more functions associated with determining financial/business goals from multiple data sources by applying artificial intelligence models.

As shown in FIG. 1, the system 100 comprises of UE 101. In one embodiment, the UE 101 may include, but is not restricted to, any type of a mobile terminal, wireless terminal, fixed terminal, or portable terminal. Examples of the UE 101, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 101 may facilitate various input means for receiving and generating information, including, but not restricted to, a touch screen capability, a keyboard, and keypad data entry, a voice-based input mechanism, and the like. Any known and future implementations of the UE 101 may also be applicable.

The UE 101 includes applications 103. Further, the applications 103 may include various applications such as, but not restricted to, content provisioning application, networking application, calendar applications, camera/imaging application, multimedia application, location-based application, and the like. In one example embodiment, the application 103 enables the data analysis platform 109 to process content information, communication information, contextual information, and/or sensor information to determine relevant goals and related contextual information for at least one user.

The system 100 also includes one or more sensors 105, which can be implemented, embedded or connected to the UE 101. The sensors 105 may be any type of sensor, e.g., a network detection sensor for detecting wireless signals or receivers for different short-range communications (e.g., Bluetooth, Wi-Fi, Li-Fi, Near Field Communication (NFC), etc.), temporal information sensors, and the like.

Further, various elements of the system 100 may communicate with each other through a communication network 107. The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5th Generation), G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the data analysis platform 109 may be a platform with multiple interconnected components. The data analysis 109 may include one or more servers, intelligent networking devices, computing devices, components and corresponding software for determining financial/business goals from multiple data sources by applying artificial intelligence models. In addition, it is noted that the data analysis 109 may be a separate entity of the system 100, a part of the one or more services 113a-113n (collectively referred to as services 113) of the services platform 111, or the UE 101.

In one embodiment, the data analysis platform 109 extracts financial planning goals from unstructured notes and correspondence logged in a relationship management system, e.g., customer relationship management (CRM), using machine-learning and Natural Language Processing (NLP). The data analysis platform 109 builds a classifier from anonymized notes data set; and then labels, tests, and refines NLP. Thereafter, the data analysis platform 109 identifies additional data elements associated with goals from unstructured data. The data analysis platform 109 refines the scope of related data for extraction, and provides leverage to advice insight model building to deliver client-centric goal-based opportunities and strategies, publish client goal tracking online, and help drive foundational advice discussions. Subsequently, the data analysis platform 109 combines unstructured data elements with known structured client data to strengthen client profile and identify sales opportunities and unimplemented recommendations. Furthermore, when combined with structured data, the accuracy of the models is improved, and new and useful information can be surfaced and delivered into CRM.

In one embodiment, the data analysis platform 109 trains artificial intelligence models to find goals, e.g., retirement, in unstructured data, e.g., CRM notes, documents, and emails. Thereafter, the data analysis platform 109 identifies key data related to the goal, e.g., the age to retire, expected age to retire, amount saving, employer match amount, etc., and extract these goal-related contextual data. The data analysis platform 109 then extract fields, e.g., cash amount, savings amount, home value, home equity line amount, life insurance amount and years remaining, disability insurance, etc., from unstructured data, and use these extracted data to add context around goals for client conversations. Subsequently, the data analysis platform 109 combines the fields surfaced from unstructured data with structured data to improve the accuracy of artificial intelligence models, validate data, and leverage for advisors and client engagement.

The services platform 111 may include any type of service. By way of example, the services platform 111 may include content (e.g., audio, video, images, etc.) provisioning services/application, application services/application, contextual information determination services/application, notification services/application, storage services/application, social networking services/application, etc. In one embodiment, the services platform 111 may interact with the UE 101, the data analysis platform 109 and the content provider 115 to supplement or aid in the processing of the content information. In one embodiment, the services platform 111 may be implemented or embedded in the data analysis platform 109 or in its functions.

By way of example, the services 113 may be an online service that reflects the interests and/or activities of users. The services 113 allow users to share contact information, location information, activities information, contextual information, historical user information and interests within their individual networks, and provides for data portability. The services 113 may additionally assist in providing the data analysis platform 109 with activity information of at least one user, user profile information, and a variety of additional information.

The content providers 115a-115n (collectively referred to as content provider 115) may provide content to the UE 101, the data analysis platform 109, and the services 113 of the services platform 111. The content provided may be any type of content, such as, image content, textual content, audio content, video content, etc. In one embodiment, the content provider 115 may provide content that may supplement the content of the applications 103, the sensors 105, or a combination thereof. In one embodiment, the content provider 115 may provide or supplement the notification services/application, social networking services/application, content (e.g., audio, video, images, etc.) provisioning services/application, application services/application, storage services/application, contextual information determination services/application, location based services/application, or any combination thereof. In one embodiment, the content provider 115 may also store content associated with the UE 101, the data analysis platform 109, and the services 113 of the services platform 111. In another embodiment, the content provider 115 may manage access to a central repository of data, and offer a consistent, standard interface to data. Any known or still developing methods, techniques or processes for determining financial/business goals may be employed by the data analysis platform 109.

By way of example, the UE 101, the data analysis platform 109 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6and layer 7) headers as defined by the OSI Reference Model.

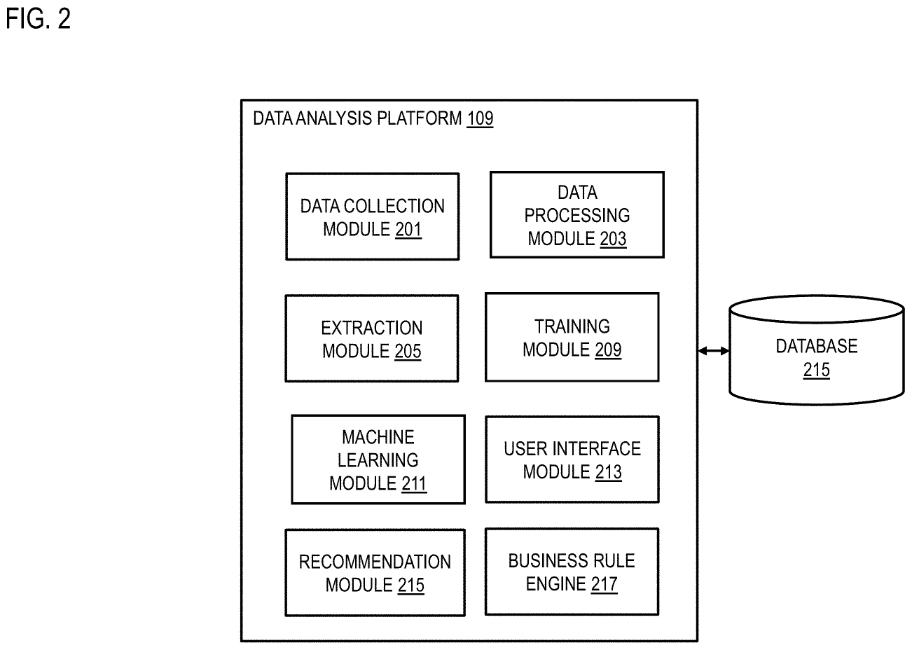

FIG. 2 is a diagram of the components of a data analysis platform 109, according to one example embodiment. By way of example, the data analysis platform 109 includes one or more components for determining financial/business goals from multiple data sources by applying artificial intelligence models. It is contemplated that the functions of these components may be combined in one or more components or performed by other components of equivalent functionality. In one embodiment, the data analysis platform 109 comprises a data collection module 201, a data processing module 203, an extraction module 205, a training module 209, the machine learning module 211, a user interface module 213, recommendation module 215, business rule engine 217, or any combination thereof.

In one embodiment, the data collection module 201 collects user data from one or more data sources and then stores the data in database 215. In one embodiment, the user data collected by the data collection module 201 are unstructured data, e.g., CRM notes, documents, and emails. In one example embodiment, the data collection module 201 may use a web-crawling component to access various websites and databases on the internet and collect data associated with the users. In another example embodiment, one or more users, e.g., members, may provide personal data, e.g., age information, education information, employment information, financial information, etc., that forms the “core data.” More subjective data, such as contextual information, activity information, preference information, may form “supplemental data.” Data such as purchase intentions may form “intention data,” that indicate intention or desire of a user to make a purchase.

In one embodiment, the data processing module 203 processes the user data collected by the data collection module 201 to find goals, e.g., the age to retire, expected year to retire, amount saving, employer match amount, etc., for one or more users. In another embodiment, the data processing module 203 processes the user data to identify key data, e.g., descriptive data, supplemental data, etc., related to the goals. In a further embodiment, the data processing module 203 processes the user data to identify any additional data elements associated with the one or more goals.

In one embodiment, the extraction module 205 extracts goal-related contextual data form the unstructured user data collected by the data collection module 201. In another embodiment, the extraction module 205 extracts one or more fields associated with the one or more goals form the unstructured user data and then use the extracted data to add context around the one or more goals for client interactions.

In one embodiment, the training module 209 trains a machine learning module 211 using various inputs to enable the machine learning module 211 to automatically find one or more goals from unstructured data. In another embodiment, the training module 209 trains a machine learning module 211 using various inputs to identify key data, e.g., descriptive data, supplemental data, etc., related to the goals. In a further embodiment, the training module 209 trains a machine learning module 211 using various inputs to enable the machine learning module 211 to combine the fields surfaced from unstructured data with structured data to improve the accuracy of artificial intelligence models, validate data, and leverage for advisors and client engagement.

In one embodiment, the user interface module 213 may generate a user interface element in response to detection of an input for a presentation of one or more data types. In one embodiment, the user interface module 213 employs various application programming interfaces (APIs) or other function calls corresponding to the application 103 of UE 101; thus enabling the display of graphics primitives such as menus, data entry fields, etc., for generating the user interface elements. Still further, the user interface module 213 may be configured to operate in connection with augmented reality (AR) processing techniques, wherein various different applications, graphic elements, and features may interact.

In one embodiment, recommendation module 215 may generate a recommendation that acts as a rule in business rule engine 217. In one embodiment, the recommendation module 215 implements a deep learning-based recommendation system which aims to provide adaptive user representations which can process many forms of user interest/signal by assessing interests over the short-term vs. long-term. In another embodiment, recommendation module 205 may present a ranking of the service providers in a user interface of UE 101 for selection by the user. The ranking of the service providers is based on service attribute information and/or user attribute information.

The above presented modules and components of the data analysis platform 109 can be implemented in hardware, firmware, software, or a combination thereof. Though depicted as a separate entity in FIG. 1, it is contemplated that the data analysis platform 109 may be implemented for direct operation by respective UE 101. As such, the data analysis platform 109 may generate direct signal inputs by way of the operating system of the UE 101 for interacting with the applications 103. In another embodiment, one or more of the modules 201-211 may be implemented for operation by respective UEs, as the data analysis platform 109, or combination thereof. Still further, the data analysis platform 109 may be integrated for direct operation with the services 115, such as in the form of a widget or applet, in accordance with an information and/or subscriber sharing arrangement. The various executions presented herein contemplate any and all arrangements and models.

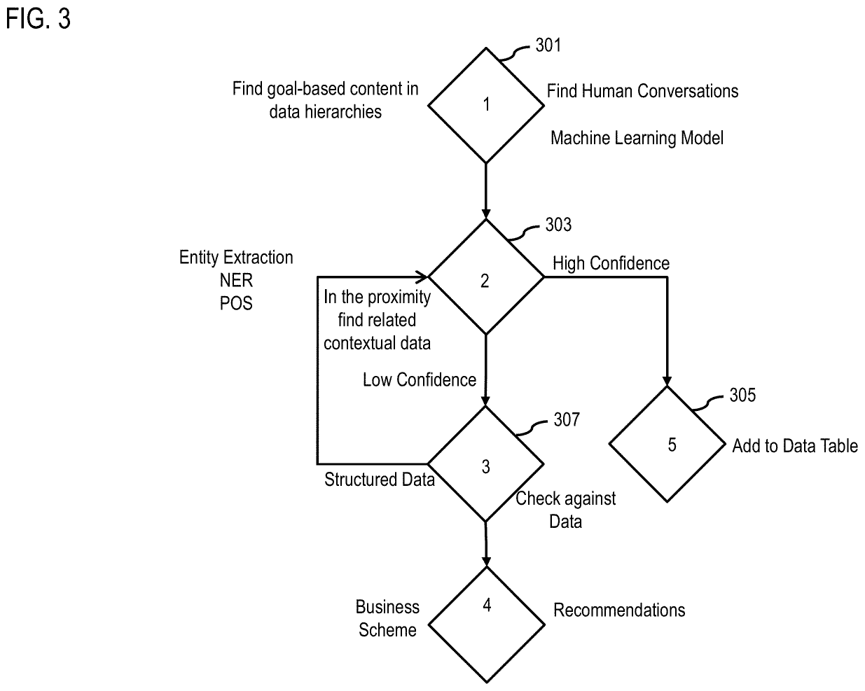

FIG. 3 is a flowchart of a process for determining financial/business goals from multiple data sources by applying artificial intelligence models, according to one example embodiment. In step 301, the data analysis platform 109 identifies relevant goals from unstructured data pertaining to at least one user via machine learning models. Thereafter, in step 303, the data analysis platform 109 finds and extracts related contextual information pertaining to the identified goals from the unstructured data. Subsequently, the processed data is classified into high confidence data and low confidence data. In step 305, the high confidence data is added to the data table. In step 307, the data analysis platform 109 evaluates the low confidence data to determine whether to add it back to the pool of unstructured data or add it to the business scheme or recommendations.

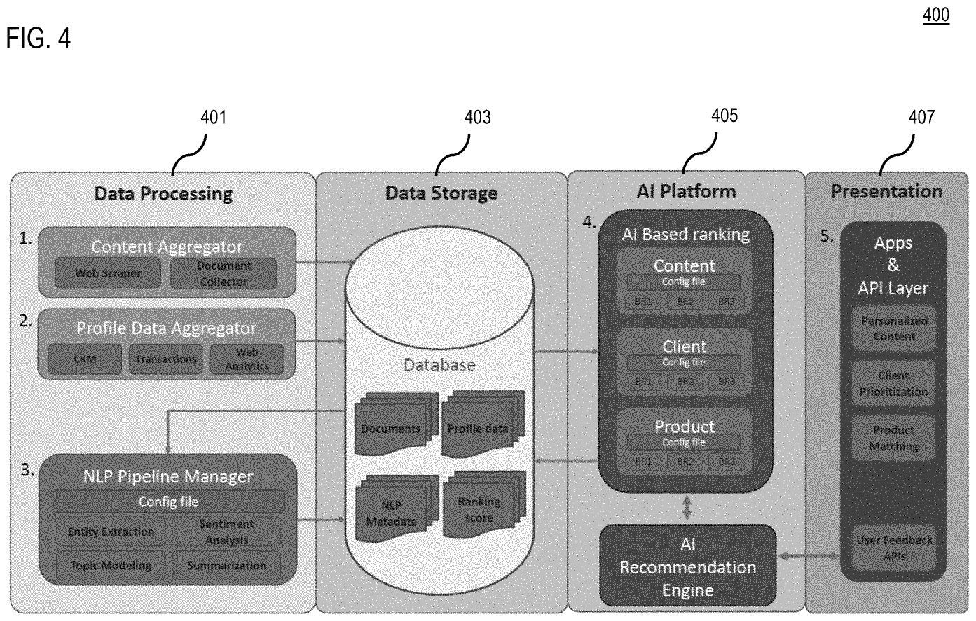

FIG. 4 is a diagram that represents a reference architecture for determining financial/business goals from multiple data sources by applying artificial intelligence models, according to one embodiment. In one embodiment, the reference architecture 400 comprises a data processing unit 401, a data storage unit 403, an AI platform 405, and a presentation module 407. In one embodiment, the data processing pipeline begins with the data analysis platform 109 aggregating various content and profile data associated with a user via a data processing unit 401. The data processing unit 401 comprises content aggregator, e.g., web scraper, various document collector mechanisms, to aggregate various content. The data processing unit 401 comprises a profile data aggregator that collects data relating to at least one user, e.g., CRM, transactions, web analytics, etc. In another embodiment, the aggregated data comprises, but is not limited to, external data, market data, premium news, external web sources, enterprise data, CRM notes, internal content, transaction, portfolio holdings, sub-holdings, etc.

In one embodiment, the data analysis platform 109 ingests the aggregated data to a data storage unit 403 via a data storage mechanism. In one embodiment, the data storage mechanism incorporates an extract, transform, and load (ETL) process. In one embodiment, the database storage mechanism, e.g., database 215, stores, but is not limited to, documents, profile data associated with at least one user, NLP metadata, ranking scores, etc.

In one embodiment, the NLP pipeline manager, a sub-component of the data processing module 401, processes the ingested aggregated data via a natural language processing (NLP) mechanism and enriches the ingested aggregated data with metadata. Thereafter, the data analysis platform 109 applies artificial intelligence (AI)/ machine learning (ML) processes, i.e., AI platform 405, on the ingested aggregated data to generate a recommendation. In one embodiment, the data analysis platform 109 may diagnose and optimize AWL models by: (i) diagnose and understand ambiguities, training data shortages, data deficiencies; and (ii) optimize models and apply to larger datasets of research news and financial content. In another embodiment, the AI platform 405 designates the ingested aggregated data according to one of a plurality of classification criteria using the artificial intelligence (AI)/ machine learning (ML) processes. Thereafter, the AI platform 405 performs an AI-based ranking based on categories, e.g., content, client, and product. In a further embodiment, an AI platform 403 performs the AI/ML processes that run signals to recommend content, product, and actions. This is then delivered to the presentation module 407 to generate a presentation in the user interface. In this embodiment, the presentation module 407 comprises of several components, e.g., personalized content, client prioritization, product matching, user feedback APIs. The presentation module 407 collaborates with an AI recommendation engine, a sub-component of the AI platform 107 to generate a recommendation.

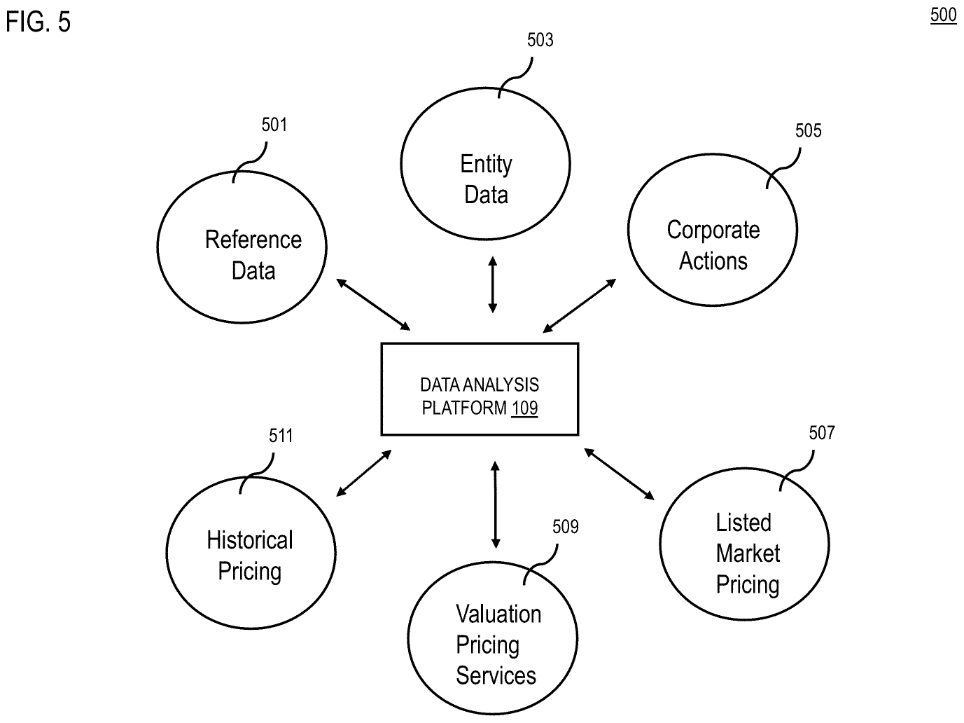

FIG. 5 is a diagram that represents a common reference data model, according to one embodiment. In one embodiment, the data analysis platform 109 processes the ingested aggregated data via an NLP mechanism and enriches the ingested aggregated data with metadata from the common reference data model 500. As depicted in FIG. 5, the common reference data model 500 comprises reference data 501, entity data 503, corporate actions 505, listed market pricing 507, valuation pricing services 509, and historical pricing 511. In one embodiment, the reference data 501 comprises of descriptive data, industry classification data, symbol/cross reference data, historical data, etc. In one embodiment, entity data 503 comprises information on global instrument-issuer linkages, parent IDs and full corporate hierarchies, audited data, etc. As discussed, entity resolution is important for AI-powered insights engines, and the classified data needs to be connected to real, live reference data. In one embodiment, corporate actions 505 comprises information on intraday activities, e.g., reports on securities that trade on the markets during regular business hours, global coverage, historical information, etc. In one embodiment, listed market pricing 507 comprises information on intraday snapshots, validated end-of-day, equity analytics fund, etc. In one embodiment, valuation pricing services 509 comprises evaluated pricing, cash flows, performance data, model analytics, etc. In one embodiment, historical pricing 511 comprises information on evaluated pricing, end-of-day pricing, etc.

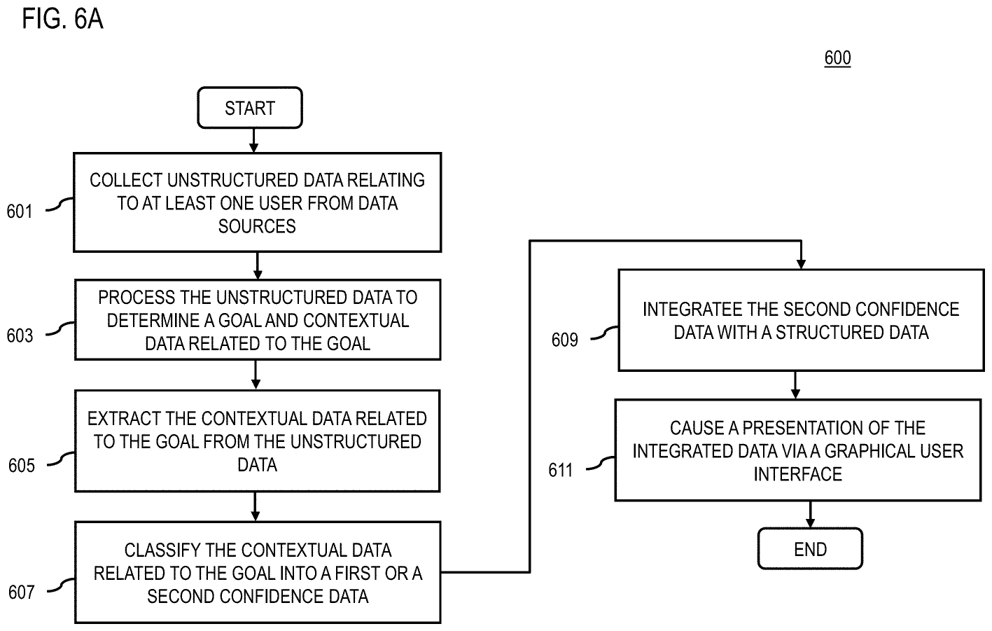

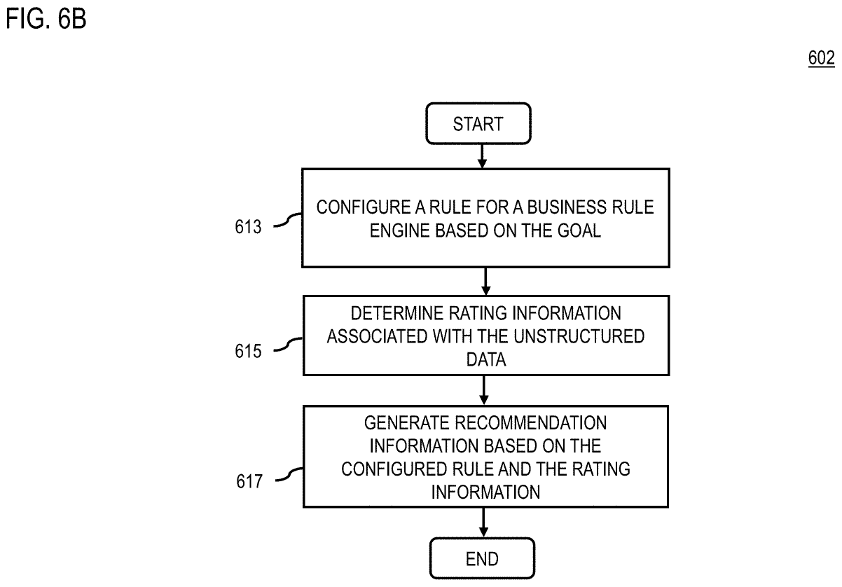

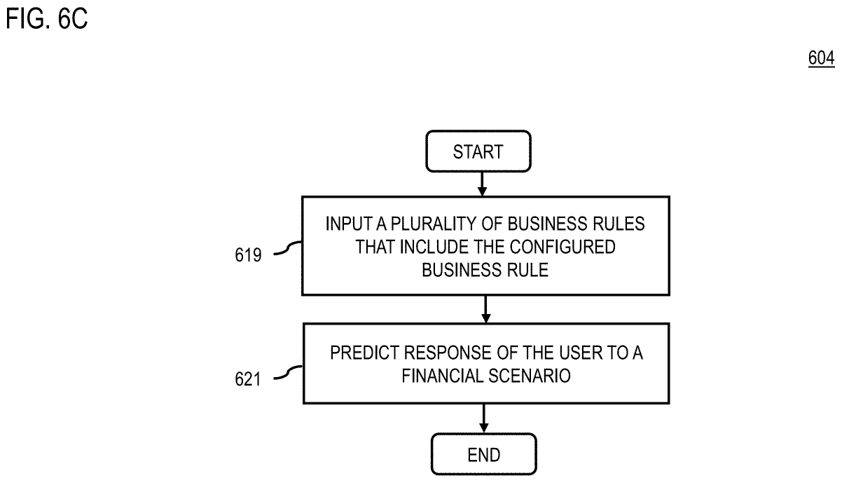

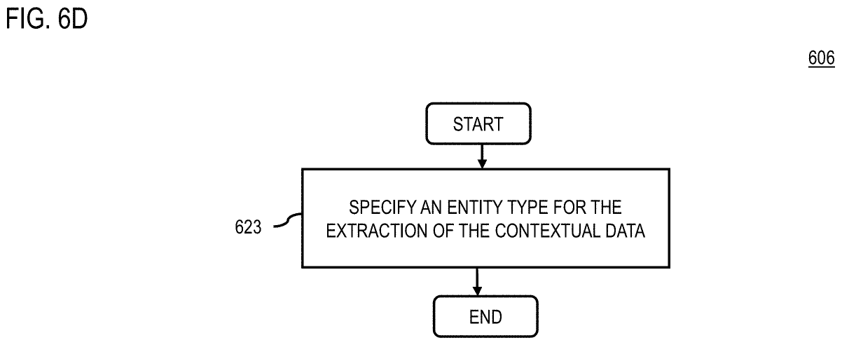

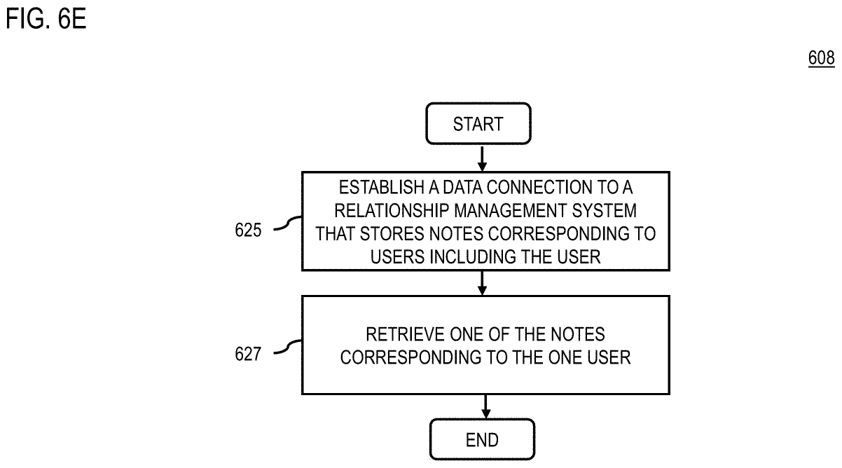

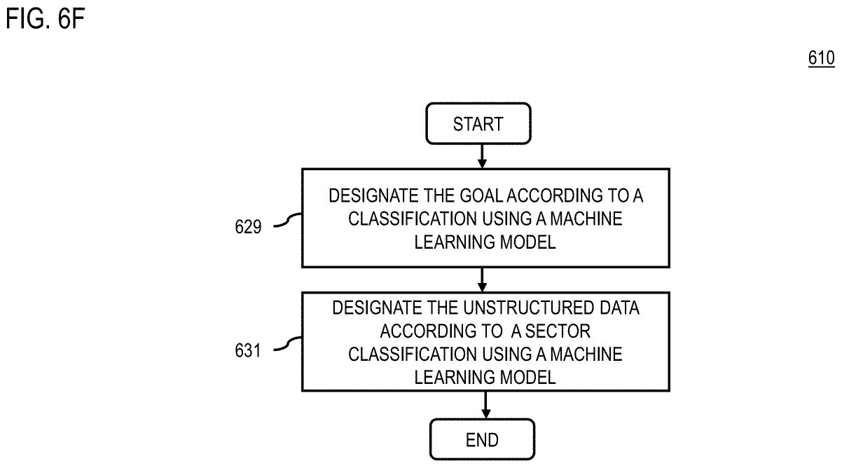

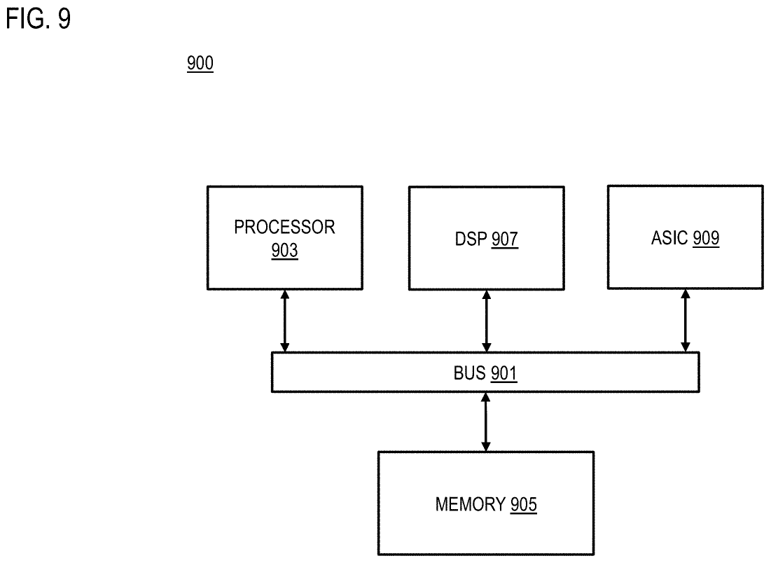

FIG. 6A is a flowchart of a process for integrating contextual data with a lower confidence level with structured data for data accuracy, according to one embodiment. In one embodiment, a data analysis platform 109 performs the process 600 and is implemented in, for instance, a chip set including a processor and a memory as shown in FIG. 9.

In step 601, the data analysis platform 109 collects unstructured data relating to at least one user from one or more data sources. In one embodiment, unstructured data includes information that either does not have a data structure or has one that is not easily usable by a computer program. In another embodiment, unstructured data may not provide any explicit data structure and instead provides dimensions or identification attributes, such as tags or metadata that may describe the unstructured data. In a further embodiment, unstructured data may have an explicit structure, but it not compatible with any applications. In addition, unstructured data may not provide a schema or other data descriptor that may be interpreted by current systems.

In step 603, the data analysis platform 109 processes the unstructured data to determine the at least one goal and contextual data related to the at least one goal. In one embodiment, the data analysis platform 109 determines the at least one goal, the contextual data related to the at least one goal, or a combination thereof based on a filtering mechanism. In one example embodiment, the filtering mechanism comprises a collaborative filtering process, a memory attention-aware recommender system (MARS), a neural collaborative filtering (NCF) framework, or a combination thereof.

In step 605, the data analysis platform 109 extracts the contextual data related to the at least one goal from the unstructured data. In one embodiment, the data analysis platform 109 extracts the contextual data related to the at least one goal from the unstructured data using a machine learning model, and the machine learning model includes a deep learning neural network.

In step 607, the data analysis platform 109 classifies the contextual data related to the at least one goal into a first confidence data or a second confidence data. In one embodiment, the first confidence data has a higher confidence level than the second confidence data.

In step 609, the data analysis platform 109 integrates the second confidence data with structured data. In one embodiment, structured data are data that have been organized into a formatted repository, typically a database, so that its elements can be made addressable for more effective processing and analysis. In one example embodiment, integrating second confidence data, i.e., data with a lower confidence level, with structured data improves the confidence level regarding data accuracy.

In step 611, the data analysis platform 109 causes a presentation of the integrated data via a graphical user interface. In one embodiment, a graphical user interface is a form of user interface that allows users to interact with electronic devices through graphical icons and audio indicators such as primary notation. In another embodiment, a graphical user interface is a system of interactive visual components for computer software that displays objects that convey information and represent actions that can be taken by the user.

FIG. 6B is a flowchart of a process for generating recommendations based on configured rule and the rating information, according to one embodiment. In one embodiment, data analysis platform 109 performs the process 602 and is implemented in, for instance, a chip set including a processor and a memory as shown in FIG. 9.

In step 613, the data analysis platform 109 configures a rule for a business rule engine based on at least one goal. In one embodiment, the data analysis platform 109 is a modular heuristics engine that combines qualitative best practices in the form of business rules/logic, as well as quantitative signals from transactions, market data, portfolios, and other numerical data. In one embodiment, the data analysis platform 109 coordinates with recommendation module 215 to generate a recommendation that acts as a rule in the business rule engine. Accordingly, the recommendation module 215 may add multiple, different, recommenders to the business rule engine, e.g., collaborative filtering (matrix factorization), Memory attention-aware recommender system (MARS), Neural Collaborative Filtering (NCF) framework, etc. In another embodiment, the data analysis platform 109 determines an important feature or a least important feature based on user inputs and preferences. In one example embodiment, the data analysis platform 109 may predict a user's response by using all the business rules as inputs.

In step 615, the data analysis platform 109 determines rating information associated with the unstructured data. In one embodiment, the data analysis platform 109 takes the star rating given to contents, e.g., rating of 1 to 5 stars, as input and provide recommendations.

In step 617, the data analysis platform 109 generates recommendation information based on the configured rule and the rating information. In one embodiment, the data analysis platform 109 is an integrated hybrid recommendation engine which provides full data auditing capabilities and reasoning. In one example embodiment, the data analysis platform 109 may use hundreds of signals with conditionality and criteria from semi-structured and unstructured data, and go beyond matrix-factorization and capture complex business patterns and correlations in behaviors that may exist across many data sources such as click-stream data from web activity, business transactions, notes from CRM and client meetings, and many other interactions and activities.

FIG. 6C is a flowchart of a process for entering business rules and predicting a user response, according to one embodiment. In one embodiment, data analysis platform 109 performs the process 604 and is implemented in, for instance, a chip set including a processor and a memory as shown in FIG. 9.

In step 619, the data analysis platform 109 inputs a plurality of business rules that include the configured business rule. In one example embodiment, the data analysis platform 109 may execute a newly configured business rule by selecting the desired business rule from configurable business rule list, for example, as enumerated in Table 1:

TABLE 1

| | Signal Category | Description of Signal |
|---|---|---|
| 1 | Holdings/Transaction | Client has recently transacted in product |
| | Pattern | that has no previous transaction activity |
| 2 | Holdings/Transaction | Halt in transactions of a product usually |
| | Pattern | purchased |
| 3 | Holdings/Transaction | Significant Redemption - Recent client |
| | Pattern | redemptions in security are above a certain |
| | | threshold |
| 4 | Holdings/Transaction | Significant Purchase - Recent client pur- |
| | Pattern | chases in security are above a certain |
| | | percentage threshold |
| 5 | Holdings/Transaction | Buying Pattern Change - YTD Sales Differ- |
| | Pattern | ence from previous year |
| 6 | Holdings/Transaction | Sub-holding of top X funds involved in |
| | Pattern | recent transactions has experienced recent |
| | | large move* |
| 7 | CRM/Relationship | Ongoing discussions - Product mentioned |
| | pattern | multiple times in recent CRM notes |
| 8 | CRM/Relationship | Sales opportunity - Product discussed |
| | pattern | during recent client interaction not in |
| | | client's recent transactions |
| 9 | CRM/Relationship | Client colleague has significant relation- |
| | pattern | ship with Firm |
| 10 | CRM/Relationship | Client has not been contacted in past X |
| | pattern | days |

In step 621, the data analysis platform 109 predicts response of the at least one user to a financial scenario. In one embodiment, the data analysis platform 109 implements a predictive analytics model that leverages historical data with goals to predict actions to take, products to sell, etc.

FIG. 6D is a flowchart of a process for extracting contextual data, according to one embodiment. In one embodiment, data analysis platform 109 performs the process 606 and is implemented in, for instance, a chip set including a processor and a memory as shown in FIG. 9.

In step 623, the data analysis platform 109 specifies an entity type for the extraction of the contextual data. In one example embodiment, entity resolution is important for AI-powered insights engines, it is not enough to correctly classify data but it has to be connected to real, live reference data. In one embodiment, the data analysis platform 109 collaborates with database 215, e.g., a comprehensive master data reference, that is seamlessly integrated with the NLP services for superior entity resolution and identification.

FIG. 6E is a flowchart of a process for managing notes corresponding to a user, according to one embodiment. In one embodiment, data analysis platform 109 performs the process 608 and is implemented in, for instance, a chip set including a processor and a memory as shown in FIG. 9.

In step 625, the data analysis platform 109 establishes a data connection to a relationship management system that stores a plurality of notes corresponding to a plurality of users including at least one user. In one embodiment, one or more data sources include the relationship management system. In one embodiment, the relationship management system provides feedback on the system that automates personalized recommendations for a user based on their business, sector, transactions, and other data.

In step 627, the data analysis platform 109 retrieves one of the notes corresponding to the one user. In one embodiment, the data analysis platform 109 builds a classifier from the anonymized notes data set. In one embodiment, the data analysis platform 109 extracts financial planning goals from CRM notes including emails, advisor notes, and other textual content. In one example embodiment, useful information on user goals and their interests is buried in CRM notes which, if surfaced, can be used for client outreach and calls that can accelerate financial planning discussions. In addition, positive and negative experiences identified in the CRM notes compare negative notes history to the current Retention Report. Furthermore, surface a user's financial goals from unstructured notes and emails logged in CRM.

FIG. 6F is a flowchart of a process for designating at least one goal and unstructured data, according to one embodiment. In one embodiment, a data analysis platform 109 performs the process 610 and is implemented in, for instance, a chip set including a processor and a memory as shown in FIG. 9.

In step 629, the data analysis platform 109 designates at least one goal according to a plurality of classifications using a machine learning model. In one embodiment, at least one goal is a primary goal or a secondary goal. In one example embodiment, the primary goal pertains to retirement information. In one example embodiment, the secondary goal pertains to education information, purchase information, and lifestyle information.

In step 631, the data analysis platform 109 designates the unstructured data according to one of a plurality of sector classifications using a machine learning model. In one embodiment, the plurality of sector classifications includes retail, technology, media, telecommunications, and food.

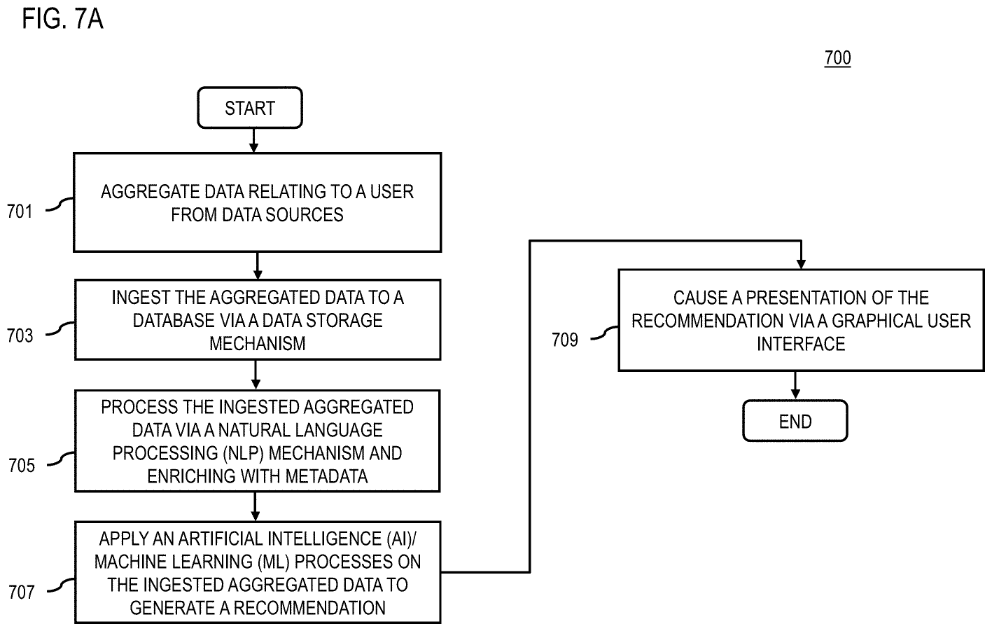

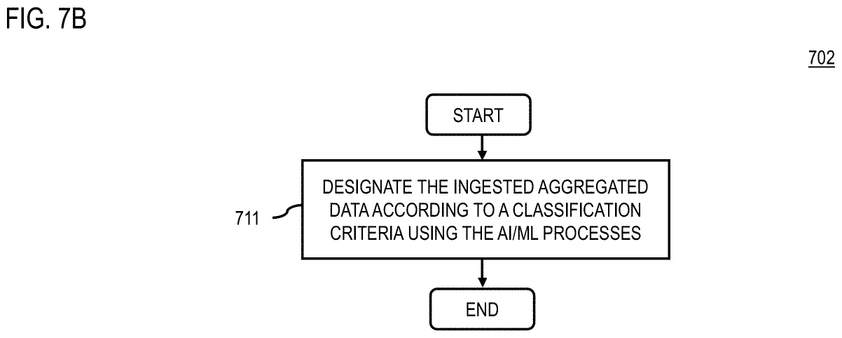

FIG. 7A is a flowchart of a process for generating a recommendation on the ingested aggregated data relating to a user, according to one embodiment. In one embodiment, a data analysis platform 109 performs the process 700 and is implemented in, for instance, a chip set including a processor and a memory as shown in FIG. 9.

In step 701, the data analysis platform 109 aggregates data relating to at least one user from one or more data sources via a data processing module. The data processing pipeline begins with the data analysis platform 109 aggregating various content and profile data associated with a user. In one embodiment, a content aggregator collects contents via web scraper, document collector, etc. In another embodiment, the profile data aggregator collects data relating to at least one user. In one embodiment, the aggregated data comprises, but is not limited to, external data, market data, premium news, external web sources, enterprise data, CRM notes, internal content, transaction, portfolio holdings, sub-holdings, etc.

In step 703, the data analysis platform 109 ingests the aggregated data to a database via a data storage mechanism. In one embodiment, the data storage mechanism incorporates an extract, transform, and load (ETL) process. In one embodiment, the database, i.e., database 215, stores, but is not limited to, documents, profile data associated with at least one user, NLP metadata, ranking scores, etc.

In step 705, the data analysis platform 109 processes the ingested aggregated data via a natural language processing (NLP) mechanism and enriches the ingested aggregated data with metadata. Thereafter, the ingested aggregated data is linked to the common data model. In one embodiment, features of a common data model comprise, but is not limited to, (i) access to broad, rich dataset over 70 million globally-sourced instruments automatically updated in a scheduled duration, e.g., every 15 minutes. In one embodiment, the data processing module is further configured to pipeline the aggregated data for the NLP mechanism, and the data processing module is further configured to perform entity extraction, sentiment analysis, topic modeling, summarization, or a combination thereof of the aggregated data.

In step 707, the data analysis platform 109 applies artificial intelligence (AI) processes, e.g., a machine learning or deep learning, on the ingested aggregated data to generate a recommendation. In one embodiment, the data analysis platform 109 may diagnose and optimize AI models by: (i) diagnose and understand ambiguities, training data shortages, data deficiencies; and (ii) optimize models and apply to larger datasets of research news and financial content. In another embodiment, an AI platform 403 performs the AI processes that run signals to recommend content, product, and actions.

In step 709, the data analysis platform 109 causes a presentation of the recommendation via a graphical user interface (e.g., UE 101) via a presentation module.

FIG. 7B is a flowchart of a process for designating the ingested aggregated data according to classification criteria, according to one embodiment. In one embodiment, a data analysis platform 109 performs the process 702 and is implemented in, for instance, a chip set including a processor and a memory as shown in FIG. 9.

In step 711, the data analysis platform 109 designates the ingested aggregated data according to one of a plurality of classification criteria using the artificial intelligence (AI) processes, e.g., a machine learning or deep learning. In one embodiment, the plurality of classification criteria includes content, client, and product.

The processes described herein for determining financial/business goals from multiple data sources by applying artificial intelligence models may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

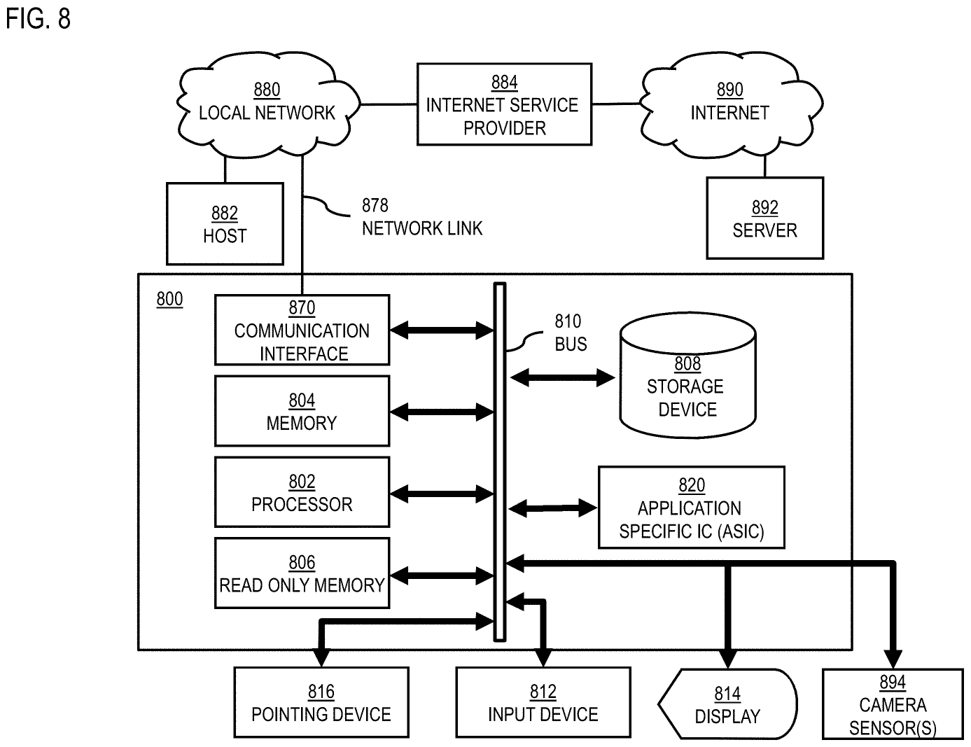

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to determine financial/business goals from multiple data sources by applying artificial intelligence models as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to determining financial/business goals from multiple data sources by applying artificial intelligence models. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for determining financial/business goals from multiple data sources by applying artificial intelligence models. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for determining financial/business goals from multiple data sources by applying artificial intelligence models, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for determining financial/business goals from multiple data sources by applying artificial intelligence models to the UE 101.

The term “computer-readable medium” is used herein to refer to any medium that participates in providing information to processor 802, including instructions for execution. Such a medium may take many forms, including, but not limited to, computer-readable storage medium (e.g., non-volatile media, volatile media), and transmission media. Non-volatile media include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to determine financial/business goals from multiple data sources by applying artificial intelligence models as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine financial/business goals from multiple data sources by applying artificial intelligence models. The memory 905 also stores the data associated with or generated by the execution of the inventive steps.

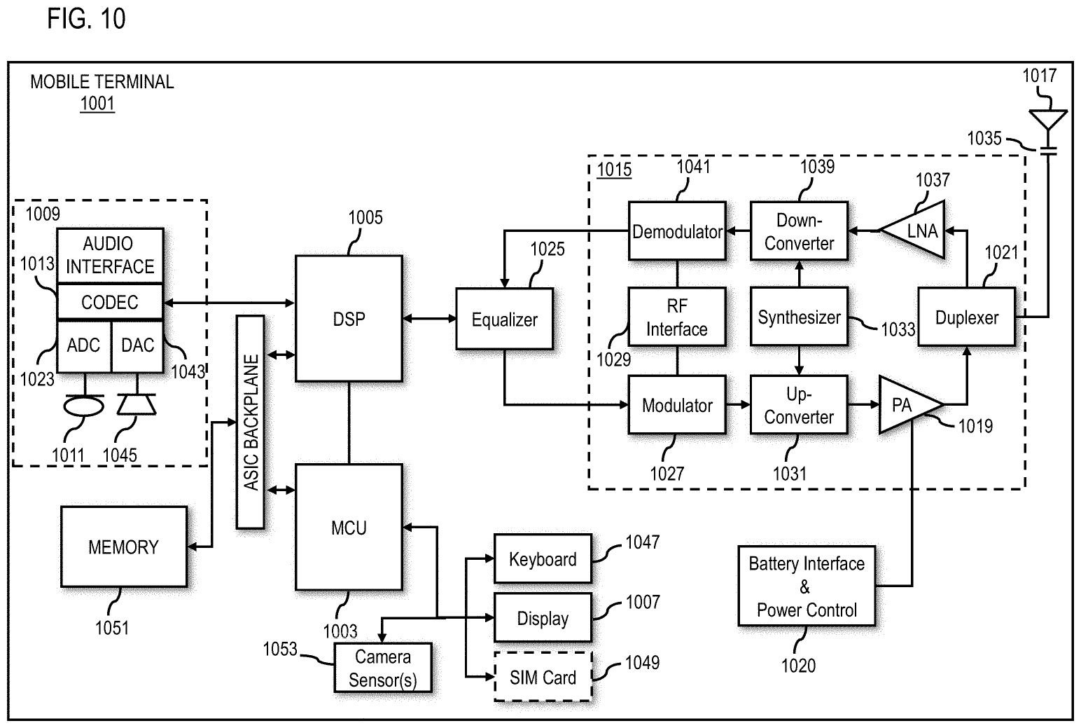

FIG. 10 is a diagram of exemplary components of a mobile terminal (e.g., handset) capable of operating in the system of FIG. 1A, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to determine financial/business goals from multiple data sources by applying artificial intelligence models. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for determining at least one goal by applying artificial intelligence, comprising:
collecting unstructured data relating to at least one user from one or more data sources;
processing the unstructured data to determine the at least one goal and contextual data related to the at least one goal;
extracting the contextual data related to the at least one goal from the unstructured data;
classifying the contextual data related to the at least one goal into a first confidence data or a second confidence data, wherein the first confidence data has a higher confidence level than the second confidence data;
integrating the second confidence data with a structured data; and
causing a presentation of the integrated data via a graphical user interface.

2. The method of claim 1, wherein the one or more data sources include financial information, the method further comprising:
configuring a rule for a business rule engine based on the at least one goal;
determining rating information associated with the unstructured data; and
generating recommendation information based on the configured rule and the rating information.

3. The method of claim 2, wherein the recommendation information specifies an action relating to a financial product or a financial action according to the at least one goal.

4. The method of claim 3, further comprising:
inputting a plurality of business rules that include the configured business rule; and
predicting response of the at least one user to a financial scenario.

5. The method of claim 1, wherein the one or more data sources include financial information, the method further comprising:
specifying an entity type for the extraction of the contextual data.

6. The method of claim 1, further comprising:
establishing a data connection to a relationship management system that stores a plurality of notes corresponding to a plurality of users including the at least one user, wherein the one or more data sources include the relationship management system; and
retrieving one of the notes corresponding to the one user.

7. The method of claim 1, further comprising:
designating the at least one goal according to a plurality of classifications using a machine learning model, wherein the at least one goal is a primary goal or a secondary goal, wherein the primary goal pertains to retirement information, and wherein the secondary goal pertains to education information, purchase information, and lifestyle information.

8. The method of claim 1, further comprising:
designating the unstructured data according to one of a plurality of sector classifications using a machine learning model, wherein the plurality of sector classifications include retail, technology, media, telecommunications, and food.

9. The method of claim 1, further comprising:
determining the at least one goal, the contextual data related to the at least one goal, or a combination thereof based on a filtering mechanism, wherein the filtering mechanism comprises a collaborative filtering, a memory attention-aware recommender system (MARS), a neural collaborative filtering (NCF) framework, or a combination thereof.

10. The method of claim 1, further comprising:
extracting the contextual data related to the at least one goal from the unstructured data using a machine learning model, and wherein the machine learning model includes a deep learning neural network.

11. An apparatus for determining at least one goal by applying artificial intelligence, comprising:
at least one processor; and
at least one memory including computer program code for one or more programs,
the at least one memory and the computer program code configured to, with the at least one processor, cause the apparatus to perform at least the following,
collect unstructured data relating to at least one user from one or more data sources;
process the unstructured data to determine the at least one goal and contextual data related to the at least one goal;
extract the contextual data related to the at least one goal from the unstructured data;
classify the contextual data related to the at least one goal into a first confidence data or a second confidence data, wherein the first confidence data has a higher confidence level than the second confidence data;
integrate the second confidence data with a structured data; and
initiate presentation of the integrated data via a graphical user interface.

12. The apparatus of claim 11, wherein the one or more data sources include financial information, the method further comprising:
configure a rule for a business rule engine based on the at least one goal;
determine rating information associated with the unstructured data; and
generate recommendation information based on the configured rule and the rating information.

13. The apparatus of claim 12, wherein the recommendation information specifies an action relating to a financial product or a financial action according to the at least one goal.

14. The apparatus of claim 13, further comprising:
input a plurality of business rules that include the configured business rule; and
predict response of the at least one user to a financial scenario.

15. The apparatus of claim 11, wherein the one or more data sources include financial information, the method further comprising:
specify an entity type for the extraction of the contextual data.

16. The apparatus of claim 11, further comprising:
establish a data connection to a relationship management system that stores a plurality of notes corresponding to a plurality of users including the at least one user, wherein the one or more data sources include the relationship management system; and
retrieve one of the notes corresponding to the one user.

17. A system for determining at least one goal by applying artificial intelligence, comprising:
a data processing module configured to aggregate data relating to at least one user from one or more data sources;
a database configured to store the aggregated data;
an artificial intelligence platform configured to process the aggregated data using a natural language processing (NLP) mechanism, to modify the aggregated data with metadata, and to apply an artificial intelligence (AI) process on the aggregated data to generate a recommendation; and
a presentation module configured to cause a presentation of the recommendation via a graphical user interface.

18. The system of claim 17, wherein the artificial intelligence platform is further configured to classify the aggregated data according to a plurality of classification criteria using the artificial intelligence (AI) process, wherein the plurality of classification criteria includes content, client, and product.

19. The system of claim 17, wherein the data processing module is further configured to pipeline the aggregated data for the NLP mechanism, and the data processing module is further configured to perform entity extraction, sentiment analysis, topic modeling, summarization, or a combination thereof of the aggregated data.

20. The system of claim 17, wherein the artificial intelligence platform is further configured to rank the aggregated data to generate the recommendation.
